(19) United States
(12) Patent Application Publication
(10) Pub. No.: US 2012/0258647 A1
(43) Pub. Date: Oct. 11, 2012

(54) GEAR CUTTING MACHINE

(75) Inventor: Hansjoerg Geiser, Wiggensbach (DE)

(73) Assignee: LIEBHERR-VERZAHNTECHNIK GMBH, Kempten (DE)

(21) Appl. No.: 13/433,062

(22) Filed: Mar. 28, 2012

(30) Foreign Application Priority Data
Mar. 29, 2011 (DE) 10 2011 015 447.7

(51) Int. Cl. B23F 3/00; B24B 53/00; B24B 51/00; B24B 41/02

(52) U.S. Cl. 451/5; 451/72; 451/119; 451/47

(57) ABSTRACT

The present disclosure relates to a gear cutting machine, having a workpiece mount and a first tool mount for a respective workpiece and tool. The first tool mount can be set into rotation about a first axis of rotation of the gear cutting machine and the workpiece mount can be set into rotation about a second axis of rotation of the gear cutting machine. The first tool mount is arranged at a machining head which is movable parallel to the second axis of rotation of the workpiece mount at a machining head over at least one first linear movement axis of the gear cutting machine. In accordance with the present disclosure, the gear cutting machine furthermore has a second machining head having a second tool mount which is movable over a second linear movement axis parallel to the first linear movement axis independently of the first machining head.

### CROSS REFERENCE TO RELATED APPLICATION

This application claims priority to German Patent Application No. 10 2011 015 447.7, entitled “Gear Cutting Machine”, filed Mar. 29, 2011, which is hereby incorporated by reference in its entirety for all purposes.

### TECHNICAL FIELD

The present disclosure relates to a gear cutting machine having a workpiece mount and a first tool mount which are movable relative to one another over movement axes of the gear cutting machine for the gear cutting processing by a tool clamped in the first tool mount of a workpiece clamped in the workpiece mount.

### BACKGROUND AND SUMMARY

Such gear cutting machines are already known in a plurality of designs. In this respect, very different configurations can be provided at movement axes of the gear cutting machine which determine the processing procedures possible with the gear cutting machine and which determine the efficiency of the procedure.

It is furthermore already known to provide two machining heads movable independently of one another about certain movement axes to be able to process a workpiece simultaneously with two tools.

It is the object of the present disclosure to provide a gear cutting machine which can be used as flexibly and efficiently as possible.

This object is achieved in accordance with the present disclosure by a gear cutting machine having a workpiece mount and a first tool mount which are movable relative to one another over movement axes of the gear cutting machine for the gear cutting processing by a tool clamped in the first tool mount of a workpiece clamped in the workpiece mount. In accordance with the present disclosure, the first tool mount can be set into rotation about a first axis of rotation (B1) of the gear cutting machine, whereas the workpiece mount can be set into rotation about a second axis of rotation (C1), with the first tool mount being arranged at a machining head which can be moved parallel to the second axis of rotation (C1) of the workpiece mount via at least one first linear movement axis (Z1) of the gear cutting machine. Provision is also made in accordance with the present disclosure that the gear cutting machine furthermore has a second machining head with a second tool mount and a second axis of rotation (B2) which can be moved independently of the first machining head via a second linear movement axis (Z2) parallel to the first linear movement axis (Z1). The two machining heads movable independently of one another in the Z direction allow a particularly flexible and efficient utilization of the gear cutting machine in accordance with the present disclosure.

The gear cutting machine in accordance with the present disclosure can in particular be a gear grinding machine. The present disclosure can, however, equally be used in gear milling machines.

The present disclosure is in this respect in particular used in gear cutting machines which have a control, such as an electronic control system, for automatically controlling the movement axes of the gear cutting machine during the gear cutting processing of a workpiece and/or during the dressing of a tool. Corresponding functions to control the movement axes of the gear cutting machine are in particular implemented in this control. The movement axes of the gear cutting machine are in this respect in particular NC axes.

Provision can furthermore be made in accordance with the present disclosure that the first machining head can be moved over a third linear movement axis (V1) and the second machining head can be moved over a fourth linear movement axis (V2) independently of one another.

Provision can likewise be made in accordance with the present disclosure that the first machining head can be pivoted over a first pivot axis (A1) and the second machining head can be pivoted over a second pivot axis (A2) independently of one another.

These further movement axes which can be controlled independently of one another allow an even more flexible use of the gear cutting machine in accordance with the present disclosure.

The third and the fourth linear movement axes (V1) and (V2) can in particular each enable a movement of the respective machining head in a plane tangential to the workpiece. Furthermore, the first and second pivot axes (A1) and (A2) can each extend perpendicular to the first and second movement axes (Z1) and (Z2) and perpendicular to the third and fourth linear movement axes (V1) and (V2). The two pivot axes (A1) and (A2) can in particular extend parallel to one another in this respect. Furthermore, the third and fourth linear movement axes (V1) and (V2) can extend in the same plane and can furthermore advantageously be parallel to one another.

In a preferred embodiment of the present disclosure, the third linear movement axis (V1) is in this respect arranged between the first pivot axis (A1) and the first linear movement axis (Z1), whereas the fourth linear movement axis (V2) is arranged between the second pivot axis (A2 and the second linear movement axis (Z2). In this respect, the first linear movement axis (Z1) and the third linear movement axis (V1) have a fixed angle with respect to one another, in particular an angle of 90°. In a further advantageous manner, the second linear movement axis (Z2) and the fourth linear movement axis (V2) have a fixed angle with respect to one another, in particular 90°. This axial arrangement is called a Z-V-A axial arrangement. Alternatively, the axes can also be arranged in a Z-A-V arrangement.

In a further advantageous manner, provision can be made that the two machining heads are arranged at a common machine stand which is movable over a fifth linear movement axis (X1) perpendicular to the second axis of rotation (C1). In this respect, guides for the movement of the two machining heads along their respective movement axes (Z1) and (Z2) are advantageously provided at the machine stand. In an advantageous manner, the respective machining heads are in this respect arranged on slides which are displaceable along these guides. The (V1) and (V2) axes are advantageously arranged perpendicular to the (Z1) and Z2) axes respectively on the slides. They are advantageously followed by the first pivot axis (A1) or the second pivot axis (A1) at which the machining head is arranged.

The gear cutting machine in accordance with the present disclosure can furthermore have a dressing unit with a first dressing tool mount so that a dressing tool received in the first dressing tool mount can be used for dressing a tool clamped in the first and/or second tool mount.

The gear cutting machine in accordance with the present disclosure is in particular in this respect a gear grinding machine whose grinding tool can be dressed via the dressing unit in accordance with the present disclosure.

The dressing unit in this respect advantageously has a first dressing tool mount which can be set into rotation about a third axis of rotation (B3). Dressing wheels can in particular thus be used as the dressing tool.

Provision is advantageously made in this respect that a tool clamped in the first and/or second tool mounts can be dressed on the gear cutting machine, while simultaneously a tool clamped in the other tool mount is used for machining a workpiece clamped in the workpiece mount. The control in particular advantageously has a corresponding function for this purpose. The gear cutting machine in accordance with the present disclosure achieves a substantially increased throughput due to the respective alternating dressing and grinding by the use of two machining heads.

In a first embodiment, the dressing unit in accordance with the present disclosure can be rigidly arranged at the gear cutting machine at least with respect to its linear movement. The dressing unit can, for example, be arranged above the machining heads at the machine stand, in particular between the respective guides of the (Z1) axis and (Z2) axis of the machining heads. The respective machining heads can then be moved toward the dressing unit over their (Z1) or (Z2) axes.

In this respect, in particular all linear relative movements between the first and/or second tool mounts and the dressing tool mount can be generated for dressing over linear movement axes of the machining head.

In an alternative embodiment, the dressing unit can in contrast be movable over a sixth linear movement axis (Z3) which extends parallel to the first and second movement axes (Z1) and (Z2). The dressing unit can hereby be moved toward the machining heads when these are to be dressed.

A common dressing unit for both machining heads can in particular be used in the gear cutting machine in accordance with the present disclosure. It is advantageously arranged in this respect between the guides of the machining heads in the (Z1) or (Z2) directions.

The dressing unit can in this respect be made rigid, as described above, or movable in a linear manner over a Z3 axis.

The dressing unit can in this respect furthermore have a second dressing tool mount beside a first dressing tool mount so that a dressing tool received in the first dressing tool mount can be used for dressing a tool clamped in the first tool mount and simultaneously a dressing tool received in the second dressing tool mount can be used for dressing a tool clamped in the second tool mount. The second dressing tool mount can in this respect advantageously be set into rotation about a fourth axis of rotation (B4). The first and second dressing mounts can in this respect in particular be arranged in a linear manner immovably with respect to one another at the dressing unit.

Gear cutting machines are, however, naturally also conceivable in which two separately movable dressing units are provided.

In a further alternative embodiment, one of the dressing units can be moved over a Z4 axis in the direction of the second dressing unit. A grinding tool can be simultaneously dressed at both flanks by this special embodiment in that the dressing tools are supplied in the Z direction in accordance with the profile shape.

Provision can furthermore be made in the gear cutting machine in accordance with the present disclosure that the tools arranged at the two dressing heads are simultaneously dressed and/or are simultaneously used for gear cutting processing. The control in particular advantageously has corresponding functions for this purpose.

In a further embodiment of the present disclosure, (galvanically) hard material coated tools (e.g., CBN coated) can be used which do not have to be dressed. The dressing unit could be dispensed with on an exclusive use of these tools.

The present disclosure furthermore includes the use of a gear cutting machine as has been described above for the gear cutting processing of a workpiece or for the dressing of a tool. The present disclosure furthermore include a method of operating a gear cutting machine as has been described above, likewise for the gear cutting processing of a workpiece and/or for the dressing of a tool. The use or the operation of the gear cutting machine in this respect advantageously takes place as has already been described above with respect to the use possibilities of the gear cutting machine in accordance with the present disclosure. The gear cutting machine in accordance with the present disclosure advantageously has the control already described above which has corresponding functions for the automatic carrying out of the method in accordance with the present disclosure.

The present disclosure furthermore includes a method of operating a gear cutting machine having a first and second machining head which can be moved independently of one another for the gear cutting processing of a tool clamped in the tool mount and a dressing unit which can be used for dressing a tool arranged at the first and/or second machining heads. Provision is made in this respect in the method in accordance with the present disclosure that the first and second machining heads are used alternately for the gear cutting processing of one or more workpieces. A particularly effective gear cutting process hereby results.

Provision can be made in this respect that the first and second machining heads are used alternately for the gear cutting processing of the same workpiece using different tools, in particular using grinding tools of different grain size. For example, in this respect the one machining head can be used for roughing, the other machining head for smoothing the same workpiece.

Provision can likewise be made that the first machining head is used for gear cutting at a workpiece while the tool of the second machining, head is dressed. In this respect, identical or different tools can be used.

A mode of operation of the gear cutting machine in accordance with the present disclosure can naturally furthermore be provided in which both machining heads are used for the simultaneous processing of a workpiece. A mode of operation can equally be provided in which both tools are dressed simultaneously.

Due to the arrangement of the two grinding heads on a common stand, a special aspect has to be taken into account with crown helical gears. If both grinding wheels are used simultaneously, the vertical offset of the engagement paths has to be compensated, due to the helical angle of the gear tooth, by different Z positions. If this is not taken into account, the highest crown points of the gear teeth are produced offset by the vertical offset of the engagement path at different width positions of the left and right flanks.

Grinding can take place using a different grinding strategy. If there is always only one wheel running and the other is just being dressed, this wheel can work exactly at the center of the gear tooth axis (one flank or both flanks). The profile for this grinding process—with a centrally arranged grinding wheel—differs considerably from the profile in which the grinding wheel engagement takes place off-center.

The method in accordance with the present disclosure is in this respect in particular a method for the operation of a gear cutting machine such as was represented above. The method in accordance with the present disclosure is furthermore in this respect advantageously designed such as has already been described above with respect to the possibilities of use of the gear cutting machine in accordance with the present disclosure.

The present disclosure furthermore includes a gear cutting machine having a control for the automatic carrying out of a method such as was described in more detail above. The gear cutting machine in this respect in particular has corresponding functions by which the corresponding processing possibilities are implemented.

The present disclosure can be used for different gear cutting processes such as gear grinding or gear milling. In this respect, in particular grinding tools or milling tools can be used as the tools.

The present disclosure can, however, particularly preferably be used in gear cutting grinding machines since the special advantages in dressing operation in accordance with the present disclosure can be made use of here. In this respect, both grinding wheels and worm grinding wheels can be used as grinding tools. Both machining heads can thus each be equipped with a grinding wheel or each can be equipped with a worm grinding wheel. It is likewise conceivable to equip one of the grinding heads with a grinding wheel and to equip the other, in contrast, with a worm grinding wheel.

The present disclosure will now be presented in more detail with reference to embodiments and to drawings.

### BRIEF DESCRIPTION OF THE FIGURES

FIG. 1 shows a first embodiment of a gear cutting machine in accordance with the present disclosure in a grinding position.

FIG. 2 shows the embodiment of the present disclosure shown in FIG. 1 in a dressing position.

FIG. 3 shows an enlarged detail of the dressing position shown in FIG. 2.

FIG. 4 shows an enlarged detail of the grinding position shown in FIG. 1.

FIG. 5 shows a second embodiment of a gear cutting machine in accordance with the present disclosure with a fixed-position dressing unit.

FIG. 6 shows the vertical offset of the line of engagement with helical gear teeth.

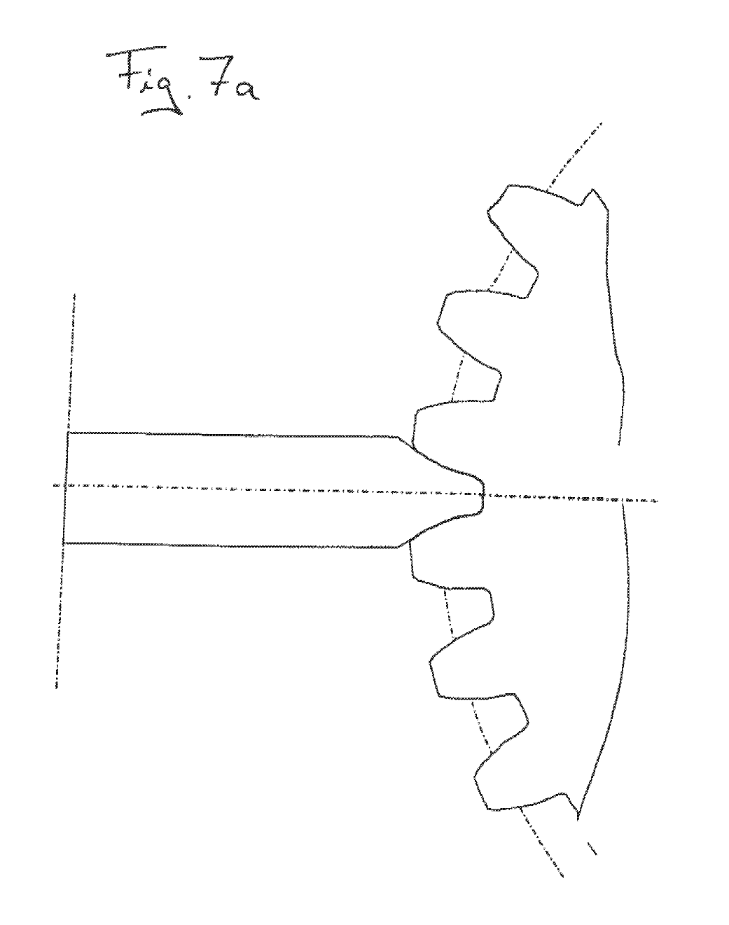

FIG. 7 shows different engagement positions of the grinding tool at the gear and the effect thereof on the grinding wheel profile. FIGS. 1-5 and 7 are drawn approximately to scale.

### DETAILED DESCRIPTION

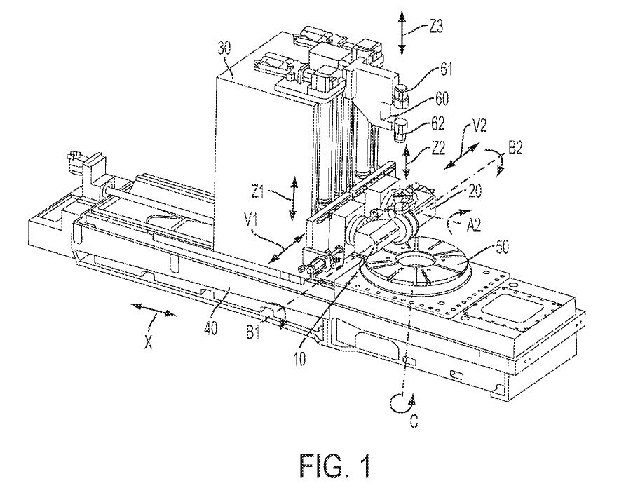

FIGS. 1 to 4 show a first embodiment of a gear cutting machine in accordance with the present disclosure. It is in this respect a gear grinding machine in the embodiment. Corresponding kinematics could, however, also be used in gear milling machines.

The gear cutting machine in accordance with the present disclosure has a first machining head 10 at which a tool can be set into rotation about an axis of rotation B1 via a corresponding tool mount. A second machining head 20 is furthermore provided at which a second tool can be arranged via a second tool mount arranged at the second machining head and can rotate about an axis of rotation B2. Corresponding drives are arranged at the first and second machining heads 10 and 20 respectively for this purpose.

The gear cutting machine in accordance with the present disclosure furthermore has a workpiece mount 50 into which a workpiece can be clamped. The workpiece mount can in this respect be driven about an axis of rotation C1. The axis of rotation C1 is in this respect arranged perpendicular in the embodiment. In one example, the workpiece mount 50 is a machine table.

The two machining heads 10 and 20 can now be moved in accordance with the present disclosure in each case separately parallel to the axis of rotation C1 of the workpiece. In this respect, a first linear movement axis Z1 is provided for moving the first machining head 10 and a second linear movement axis Z2 is provided for moving the second machining head 20.

The first machining head 10 furthermore has a third linear movement axis V1 and a pivot axis A1 by which the first machining head can be moved in a linear manner in a direction perpendicular to the Z1 axis independently of the second machining head and can be pivoted about the A1 axis standing perpendicular on the Z1 axis and on the V1 axis. The second machining head accordingly has a fourth movement axis V2 and a second pivot axis A2.

In the embodiment, in this respect, the first and the third linear movement axes Z1 and V1 are arranged non-rotatably and perpendicular to one another, as are the second linear movement axis Z2 and the fourth linear movement axis V2. In the embodiment, the Z axes thus each extend vertically; the V axes, in contrast, horizontally. The V axes are in this case each arranged between the A axes and the Z axes.

Alternatively, however, an arrangement of the A axes in each case between the Z and V axes would also be possible. In this respect, the V axes can in particular each be arranged parallel to the axes of rotation B1 and B2 respectively for the tool mounts and can thus enable a classical shifting of the tools. In this axial arrangement, the V axis is pivoted with the A axis. The V axis thus no longer extends horizontally and also no longer stands perpendicular on Z.

in accordance with the present disclosure, a common machine stand 30 is furthermore provided at which both machining heads are arranged. It has guides at which respective slides can be moved in the Z direction on which then the machining heads are respectively arranged. The machine stand 30 is movable over a linear movement axis X in the radial direction with respect to a machine table 50 on which the tool mount is arranged. The supply movement toward the workpiece or away from the workpiece is thus identical for both machining heads. Otherwise the two machining heads can, in contrast, be respectively controlled independently of one another.

In an alternative embodiment, the table can be moved radially in the X direction toward a fixed-position machine stand (30).

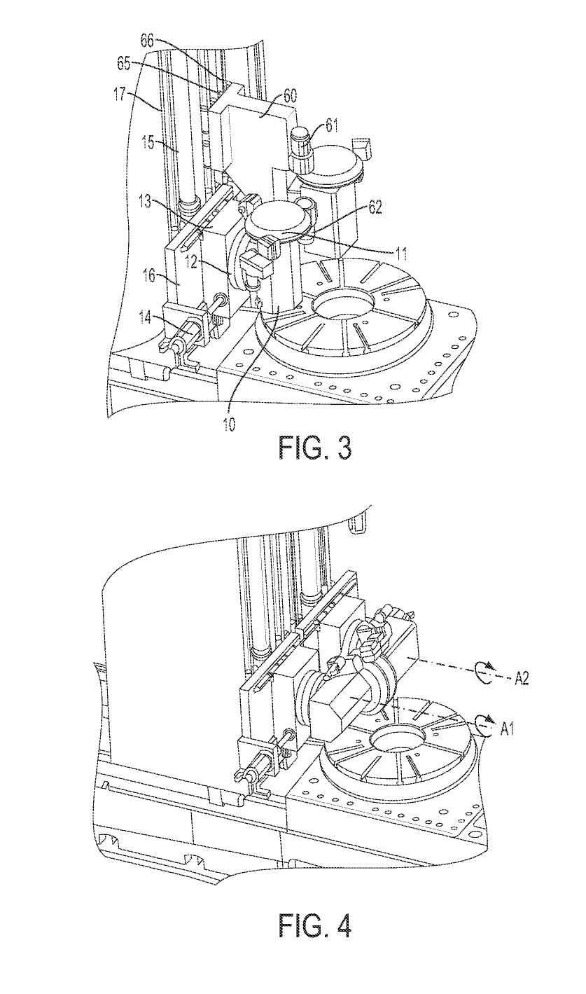

In FIG. 3, the arrangement of the machining heads 10 and 20 at the machine stand 30 can be recognized in more detail. In this respect, the machining head 10 is arranged via a pivotal joint 12 at a slide 13, with the pivotal joint 12 enabling the pivoting about the A1 axis. The pivotal joint 12 could also be a direct drive motor. The slide 13 is arranged on a guide at a further slide 16 and provides the V1 axis. A drive motor 14 is provided for driving the slide 13 along the guide. The slide 16 is in turn supported on guides 17 at the machine carrier in the Z1 direction and can be driven by a drive arranged there, with a bail screw spindle 15 or a linear motor being provided for moving the slide 16. The second machining head 20 is arranged in an identical manner at the machine stand 30.

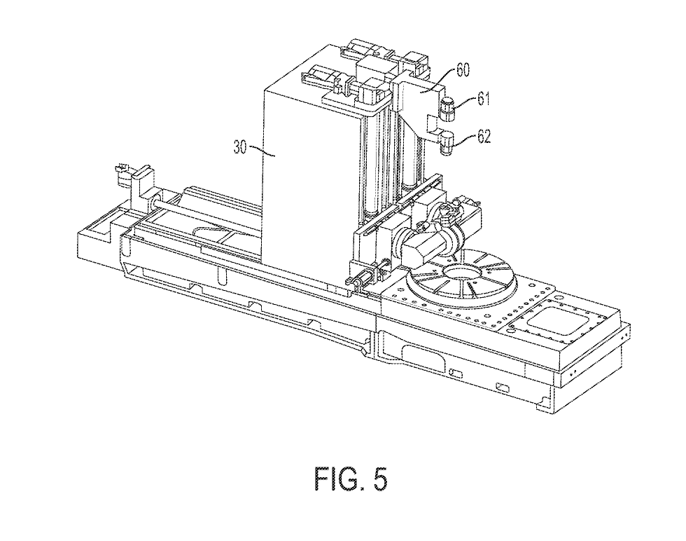

In FIG. 1, the gear cutting machine in accordance with the present disclosure is shown in a first machining mode in which both machining heads are used for processing a workpiece which was not shown for reasons of clarity. The corresponding situation is shown again enlarged in FIG. 4. It can be seen in this respect that the two machining heads are each pivoted over the pivot axes A2 and A2 respectively so that the axes of rotation B1 and B3 for the tools are aligned parallel to one another.

In a further operating mode of the gear cutting machine in accordance with the present disclosure, in contrast, one of the machining heads can be used for machining a workpiece, while the other machining head is simultaneously dressed. For this purpose, the respective machining head is pivoted for dressing over the A1 axis or A2 axis into a dressing position, while the respective other machining head is pivoted into a grinding position.

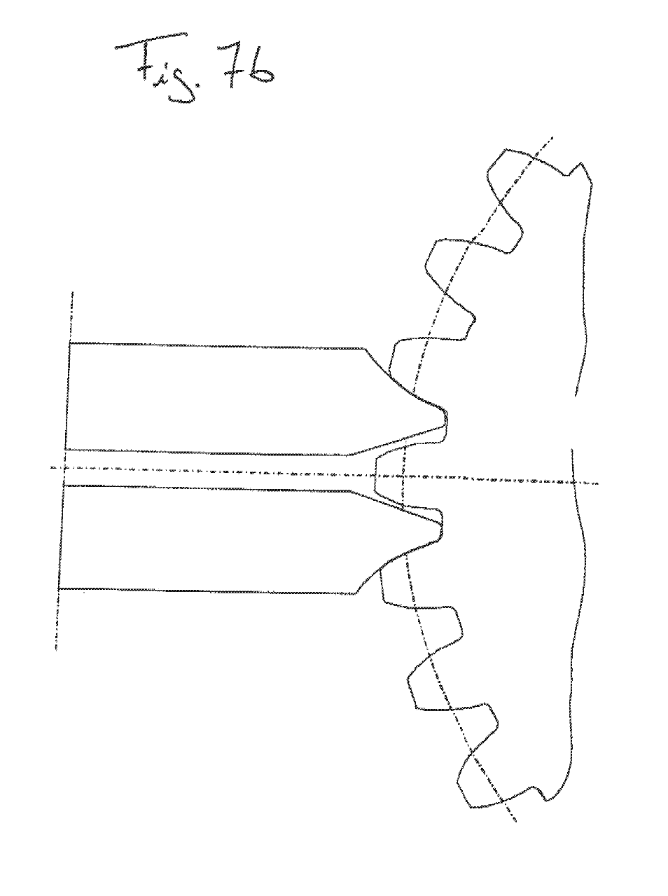

As shown in FIG. 7, different dressing profiles can be prepared on the grinding tools in dependence on the operating mode depending on whether the tool is processing the tooth gap centrally or off-center with respect to the workpiece.

In accordance with the present disclosure, a dressing unit 60 is provided for the dressing and is arranged above the machining heads at the machine stand 30. The dressing unit 60 is in this respect arranged between the two machining heads so that both machining heads can be dressed via the dressing unit.

The dressing unit 60 in accordance with the present disclosure has the special aspect that it has two dressing tool mounts 61 and 62 which can each accept and set into rotation dressing tools 63 and 64 respectively separately from one another. The two dressing tool mounts are in this respect arranged over one another in the Z direction. It is hereby possible to dress both tools simultaneously. The supply axis Z4 is to be taken into account in this respect.

An embodiment having only one dressing unit is also possible within the framework of the present disclosure. In a further alternative embodiment, the axes of the dressing tools B3 and B4 are aligned parallel to the V1/V2 axes.

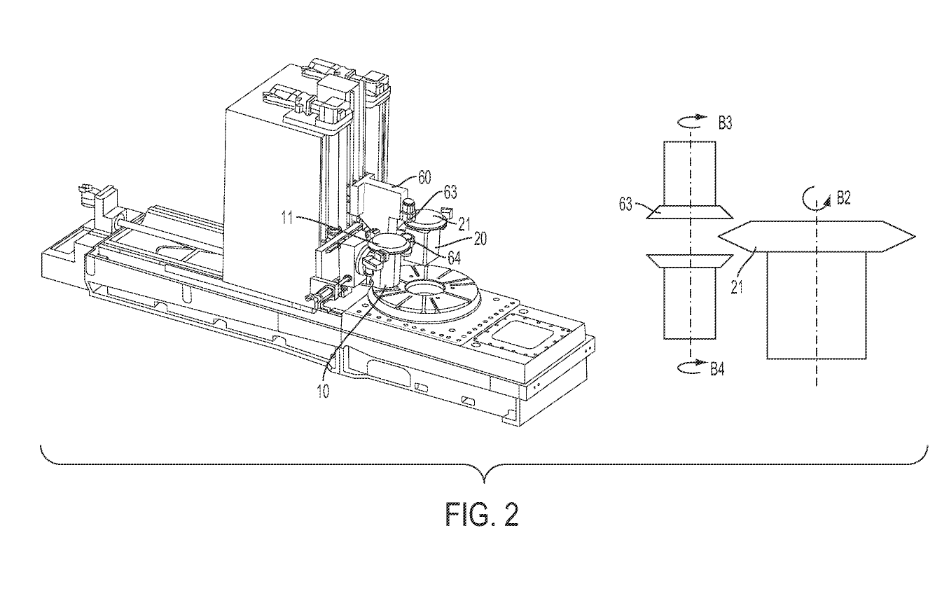

For this purpose, as shown in FIGS. 2 and 3, both machining heads are rotated into the dressing position so that the axes of rotation B1 and B2 are each vertically aligned. In this embodiment, in this respect, the axis of rotation B1 and B2 respectively of the respective tools 11 and 21 is arranged parallel to the Z1 axis or the Z2 axis. Furthermore, in the embodiment, the respective axis of rotation of the dressing tool is arranged parallel to the axis of rotation of the tool to be dressed. This is in particular shown in the enlarged representation in FIG. 2 with reference to the second machining head with the tool 21 and the dressing tool 63 associated therewith. In this respect, the respective axes of rotation B2 and B3 are arranged in parallel. The respective relative movements between the dressing tool and the tool for producing the desired profile are in this respect advantageously carried out over the movement axes of the machining head, in particular over its Z and V axes. It is hereby also possible, for example, to generate different respective profiles on the two tools.

in the embodiment shown in FIGS. 1 to 4, the dressing unit 60 can be moved in a linear manner over a Z3 axis parallel to the Z1 and Z3 axis. For this purpose, in the embodiment, the respective middle rails via which the slides of the two machining heads are guided in the Z1 and Z2 direction respectively are simultaneously used as guide rails for the dressing unit 60. A separate guide for the dressing unit 60 is, however, naturally also conceivable. The dressing unit 60 can thus be moved down to the machining heads for the dressing.

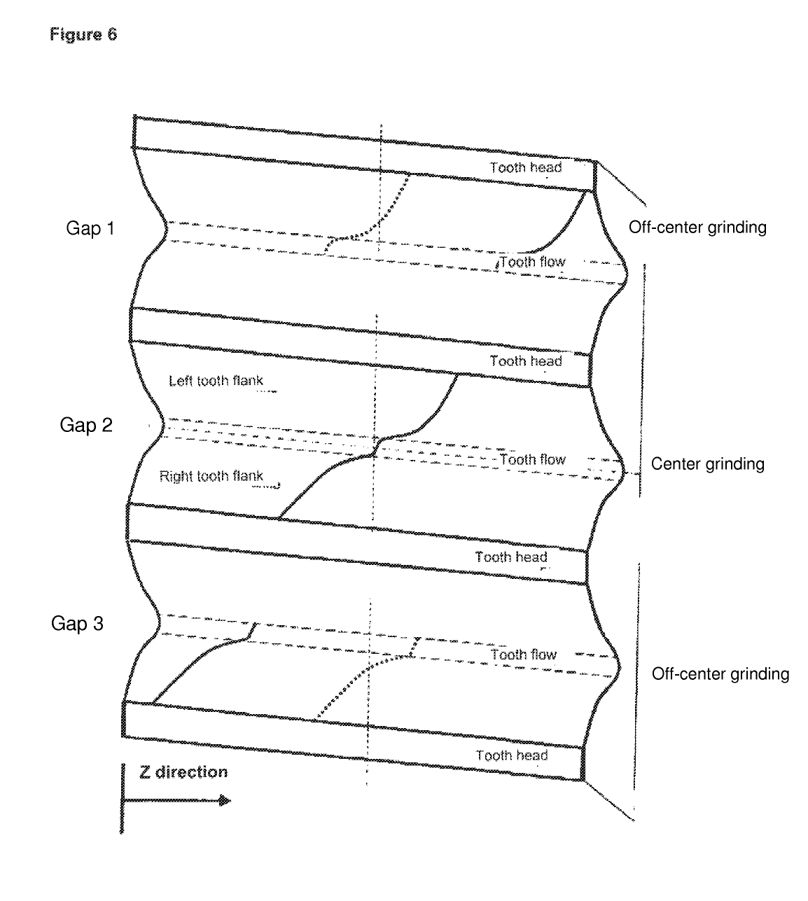

In the alternative embodiment shown in FIG. 5, the dressing unit 60 is, in contrast, rigidly arranged at the machine carrier 30. The respective machining heads must therefore here be moved toward the dressing unit over the Z1 axis or Z2 axis. Otherwise the embodiment in FIG. 5 corresponds to the embodiment shown in FIGS. 1 to 4.

The gear cutting machine in accordance with the present disclosure can be used extremely flexibly in a plurality of operating modes by the two separately movable machining heads. The gear cutting machine in this respect in particular has a control for the automatic control of the movement axes of the gear cutting machine. For example, the gear cutting machine may include an electronic control system having computer readable storage media with code for carrying out the operations described herein. In this respect, respective corresponding functions are integrated in the control for carrying out the different grinding and dressing options.

1. A gear cutting machine, having a workpiece mount and a first tool mount which are movable relative to one another over movement axes of the gear cutting machine for gear cutting processing by a tool clamped in the first tool mount of a workpiece clamped in the workpiece mount, wherein the first tool mount is settable into rotation about a first axis of rotation of the gear cutting machine and the workpiece mount is settable into rotation about a second axis of rotation of the gear cutting machine and wherein the first tool mount is arranged at a first machining head which is movable parallel to the second axis of rotation via at least one first linear movement axis of the gear cutting machine and wherein the gear cutting machine has a control for the automatic control of the movement axes of the gear cutting machine during the gear cutting processing of the workpiece and/or during dressing of the tool, wherein the gear cutting machine furthermore has a second machining head with a second tool mount and a second axis of rotation which is moved independently of the first machining head via a second linear movement axis parallel to the first linear movement axis.

2. The gear cutting machine in accordance with claim 1, wherein the first machining head is movable over a third linear movement axis and the second machining head is movable over a fourth linear movement axis independently of one another; and/or wherein the first machining head is pivotable over a first pivot axis and the second machining head is pivotable over a second pivot axis independently of one another; wherein the third linear movement axis advantageously is arranged between the first pivot axis and the first linear movement axis and the fourth linear movement axis between the second pivot axis and the second linear movement axis; and/or wherein the two machining heads are arranged at a common machine stand which is movable perpendicular to the second axis of rotation.

3. The gear cutting machine in accordance with claim 1, wherein the gear cutting machine furthermore has a dressing unit having a first dressing tool mount so that a dressing tool received in the first dressing tool mount can be used for dressing a tool clamped in the first and/or second tool mount; wherein the first dressing tool mount can advantageously be set into rotation about a third axis of rotation; and wherein a tool clamped in the first and/or second tool mount can advantageously be dressed on the gear cutting machine, while simultaneously a tool clamped in the second tool mount is used for processing a workpiece clamped in the workpiece mount.

4. The gear cutting machine in accordance with claim 3, wherein a drive unit is arranged rigidly at the gear cutting machine at least with respect to linear movements and/or all relative linear movements between the first and/or second tool mounts and the dressing tool mount can be produced over linear movement axes of the machining head for the dressing.

5. The gear cutting machine in accordance with claim 3, wherein the dressing unit is movable via a sixth linear movement axis which extends parallel to the first and second movement axes.

6. The gear cutting machine in accordance with claim 3, wherein the dressing unit furthermore has a second dressing tool mount so that a dressing tool received in the first dressing tool mount can be used for dressing a tool clamped in the first tool mount and simultaneously a dressing tool received in the second dressing tool mount can be used for dressing a tool clamped in the second tool mount; wherein the second dressing tool mount can advantageously be set into rotation about a fourth axis of rotation; and/or wherein the first and second dressing tool mounts are arranged in a linear manner immovably at the dressing unit; and/or wherein the dressing unit can be moved in a linear manner toward the second dressing unit.

7. The gear cutting machine in accordance with claim 1, wherein the gear cutting machine is a gear grinding machine.

8. The gear cutting machine in accordance with claim 1, further comprising an electronic control system with instructions to operate both machining heads simultaneously at different Z positions in dependence on a vertical offset of a line of engagement calculated for crown and helical gear teeth in order to correct the vertical offset of the line of engagement between left and right flanks.

9. A method of operating a gear cutting machine, having a first and a second machining head which are movable independently of one another for gear cutting processing of a workpiece clamped in a workpiece mount, wherein both machining heads are used simultaneously at different Z positions in dependence on a vertical offset of a line of engagement in order to correct the vertical offset of the line of engagement between left and right flanks.

10. The method in accordance with claim 8, wherein the line of engagement is a line of engagement calculated for crown and helical gear teeth.

11. A method of operating a gear cutting machine having a first and a second machining head which can be moved independently of one another for gear cutting processing of a workpiece clamped in a workpiece mount and having a dressing unit, comprising using the dressing unit to dress a tool arranged at the first and/or second machining head, wherein the first and second machining heads are used alternately for the gear cutting processing of one or more workpieces.

12. The method in accordance with claim 9, wherein dressing and grinding take place simultaneously, with a single-flank grinding or a two-flank grinding taking place.

13. The method in accordance with claim 10, wherein the first machining head and the second machining head are used alternately for the gear cutting of the same workpiece using different tools, in particular using grinding tools of different grain size; and/or wherein the first machining head is used for the gear cutting processing of a workpiece, while the tool of the second machining head is dressed.
